(19) United States
(12) Patent Application Publication
(10) Pub. No.: US 2024/0348545 A1
(43) Pub. Date: Oct. 17, 2024

(54) MULTI-NODE SERVER NETWORK SYSTEM

(71) Applicant: ASRock Rack Incorporation, Taipei City (TW)

(72) Inventor: Chong-Kim Chan, Taipei City (TW)

(73) Assignee: ASRock Rack Incorporation, Taipei City (TW)

(21) Appl. No.: 18/617,884

(22) Filed: Mar. 27, 2024

(30) Foreign Application Priority Data
Apr. 14, 2023 (TW) 112203475

(51) Int. Cl. H04L 45/745; H04L 12/46; H04L 61/50

(52) U.S. Cl. CPC H04L 45/745; H04L 12/4641; H04L 61/50

(57) ABSTRACT

Disclosed is a multi-node server network system including a chassis manager for managing a plurality of server nodes. The chassis manager is configured to: assign a plurality of virtual network addresses to the server nodes respectively; set up a plurality of port numbers respectively for the server nodes based on a specific network address; establish a mapping table between the virtual network addresses and the port numbers; find, in response to receiving a first data packet corresponding to a first port number among the port numbers, a first virtual network address corresponding to the first port number from the virtual network addresses based on the mapping table, and forward the first data packet to a first server node corresponding to the first virtual network address among the server nodes.

### CROSS-REFERENCE TO RELATED APPLICATION

This application claims the priority benefit of Taiwan application serial no. 112203475, filed on Apr. 14, 2023. The entirety of the above-mentioned patent application is hereby incorporated by reference herein and made a part of this specification.

### BACKGROUND

### Technical Field

The disclosure relates to a multi-node server network system.

### Description of Related Art

A multi-node server is a computer server designed with two or multiple independent server nodes to increase computing density. The server nodes share a single chassis and one or multiple power supplies. In the multi-node server, power is distributed to all server nodes through a shared power supply.

Because of high computing capabilities, the multi-node servers are widely used in applications of high-density or requirements for large-scale access operations.

In a structure of a multi-node server network, each of the server node needs to be configured with a corresponding independent network interface. Moreover, each network interface requires an independent network cable and occupies a unique network address (for example, an internet protocol (IP) address), which may consume too many network cables and network addresses.

### SUMMARY

In view of this, the disclosure provides a multi-server network system which can be configured to solve the above-mentioned technical problems.

An embodiment of the disclosure provides a multi-server network system including a chassis manager managing a plurality of server nodes. The chassis manager is configured to: assign a plurality of virtual network addresses to the server nodes respectively, set up a plurality of port numbers respectively for the server nodes based on a specific network address, establish a mapping table between the virtual network addresses and the port numbers, find, in response to receiving a first data packet corresponding to a first port number among the port numbers, a first virtual network address corresponding to the first port number from the virtual network addresses based on the mapping table, and forward the first data packet to a first server node corresponding to the first virtual network address among the server nodes.

Based on the above, embodiments of the disclosure provide the multi-node server network system to improve an effect of saving network cables and network addresses.

### BRIEF DESCRIPTION OF THE DRAWINGS

FIG. 1 is a schematic diagram of a multi-node server network system according to an embodiment of the disclosure.

FIG. 2 is a flowchart of a method for managing a multi-node server according to an embodiment of the disclosure.

### DESCRIPTION OF THE EMBODIMENTS

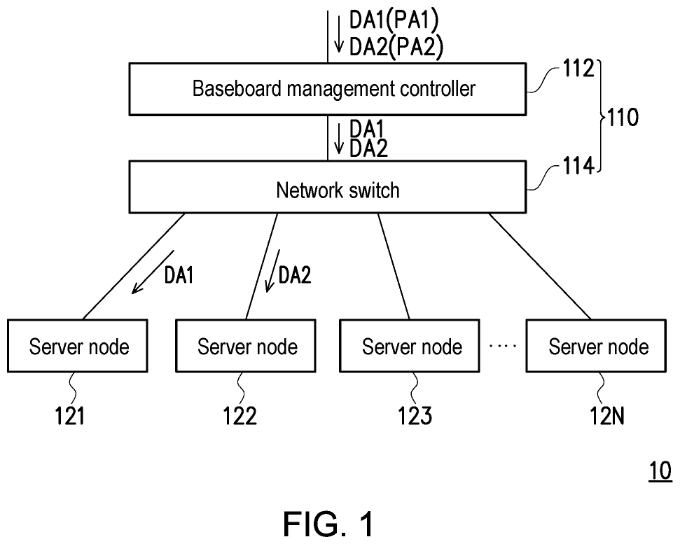

Referring to FIG. 1, FIG. 1 is a schematic diagram of a multi-node server network system according to an embodiment of the disclosure. In FIG. 1, a multi-node server network system 10 includes a chassis manager 110 and a plurality of server nodes 121 to 12N (N is a positive integer).

In an embodiment of the disclosure, the chassis manager 110 may include a baseboard management controller 112 and a network switch 114, where the network switch 114 may be connected between the baseboard management controller 112 and the server nodes 121 to 12N. Each of the server nodes 121 to 12N may perform a data exchange with an external device of the multi-node server network system 10 by the network switch 114 and the baseboard management controller 112. However, the disclosure is not limited thereto.

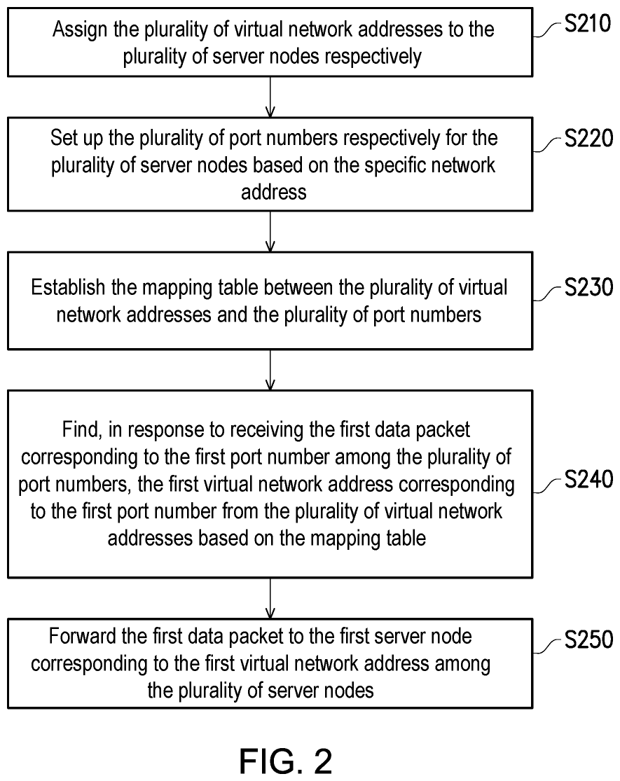

Referring to FIG. 2, FIG. 2 is a flowchart of a method for managing a multi-node server according to an embodiment of the disclosure. The method of this embodiment may be executed by the chassis manager 110 in FIG. 1. Details of each step in FIG. 2 are described below with reference to components shown in FIG. 1.

First, in step S210, the chassis manager 110 assigns a plurality of virtual network addresses to the server nodes 121 to 12N respectively. In an embodiment, the baseboard management controller 112 in the chassis manager 110 may assign the plurality of virtual network addresses to the server nodes 121 to 12N respectively, but the disclosure is not limited thereto.

In an embodiment, for an i-th server node (“ ” is an index value) among the server nodes 121 to 12N, the virtual network address assigned by the baseboard management controller 112 is, for example, “192.168.50. i”. The server node 121 (that is, a first server node) is taken as an example, and the virtual network address of the server node 121 is, for example, 192.168.50.1. A server node 122 (that is, a second server node) is taken as an example, and the virtual network address of the server node 122 is, for example, 192.168.50.2. However, the disclosure is not limited thereto.

In step S220, the chassis manager 110 sets a plurality of port numbers respectively for the server nodes 121 to 12N based on a specific network address (hereinafter referred to as IPA). In an embodiment, the baseboard management controller 112 of the chassis manager 110 may set up the plurality of port numbers respectively for the server nodes 121 to 12N based on the specific network address IPA.

In an embodiment, the specific network address IPA is, for example, the IP address obtained by the baseboard management controller 112 from an external network and corresponds to the baseboard management controller 112, and the baseboard management controller 112 may assign a corresponding port number to the server nodes 121 to 12N accordingly.

For convenience in description, it is assumed that the port numbers corresponding to the server nodes 121 to 12N are 1 to N respectively. In this case, for any one of the server nodes 121 to 12N (hereinafter referred to as the first server node), the baseboard management controller 112 may assign a corresponding port number (hereinafter referred to as a first port number PA1) to the first server node according to the specific network address IPA and a port number of the first server node (hereinafter referred to as pn).

In an embodiment, the first port number PA1 of the first server node may be represented as “IPA: pn”, but the disclosure is not limited thereto.

In an embodiment, it is assumed that the specific network address IPA is “123.234.56.78”, and then the port number corresponding to the server node 121 is, for example, “123.234.56.78:1.” Similarly, the port numbers corresponding to the server nodes 122 to 12N are, for example, “123.234.56.78:2” to “123.234.56.78: N” respectively. However, the disclosure is not limited thereto.

After determining the virtual network addresses and the port numbers corresponding to the server nodes 121 to 12N, in step S230, the chassis manager 110 establishes a mapping table between the plurality of virtual network addresses and the plurality of port numbers. In an embodiment, the baseboard management controller 112 may establish the mapping table (hereinafter referred to as T) between the plurality of virtual network addresses and the plurality of port numbers.

In the embodiment of the disclosure, a content of the mapping table T may be exemplified in Table 1 below. However, such descriptions merely serve as an example and shall not be construed as limitations on possible embodiments of the disclosure.

TABLE 1

| Server node | Virtual network address | Port number |
|---|---|---|
| 121 | 192.168.50.1 | 123.234.56.78:1 |
| 122 | 192.168.50.2 | 123.234.56.78:2 |
| 123 | 192.168.50.3 | 123.234.56.78:3 |
| . . . | . . . | . . . |
| 12N | 192.168.50.N | 123.234.56.78:N |

In an embodiment, after establishing the mapping table T, the baseboard management controller 112 may provide the mapping table T to the network switch 114.

Afterwards, in step S240, in response to receiving a first data packet (hereinafter referred to as DA1) corresponding to the first port number among the plurality of port numbers, the chassis manager 110 finds a first virtual network address corresponding to the first port number from the plurality of virtual networks based on the mapping table T.

In an embodiment, the baseboard management controller 112 may receive the first data packet DA1 from an outside of the multi-node server network system 10, and a target address of the first data packet DA1 comprises the specific network address and the first port number PA1 of the first server node.

For convenience in description, it is assumed that the first server node is considered as the server node 121. In this case, the first port number PA1 in the first data packet DA1 is, for example, “123.234.56.78:1” as shown in Table 1.

In an embodiment, when a user wants to access the server node 121, a data packet (for example, the first data packet DA1) with a target address “123.234.56.78:1” may be sent to the chassis manager 110 accordingly, but the disclosure is not limited thereto.

In an embodiment, when the baseboard management controller 112 receives the first data packet DA1 with the first port number PA1, the baseboard management controller 112 may forward the first data packet DA1 to the network switch 114. Correspondingly, the network switch 114 may find the first virtual network address corresponding to the first port number PA1 based on the mapping table T (for example, the virtual network address “192.168.50.1” corresponding to the server node 121 in Table 1).

Afterwards, in step S250, the chassis manager 110 forwards the first data packet DA1 to the first server node (for example, the server node 121) with the first virtual network address (for example, “192.168.50.1”) among the plurality of server nodes 121 to 12N.

In an embodiment, the first data packet DA1 may be forwarded to the first server node with the first virtual network address by the network switch 114.

In an embodiment, each of the server nodes 121 to 12N may be configured with a corresponding node baseboard management controller. Based on this, when the server node 121 receives the first data packet DA1 from the network switch 114, the node baseboard management controller of the server node 121 may perform corresponding data processing on the first data packet DA1. However, the disclosure is not limited thereto.

It may be seen that each of the server nodes 121 to 12N in the multi-node server network system 10 neither needs an independent outdoor network cable nor needs to be configured with a unique IP address. Thereby, costs and complexity of deploying the multi-node server network system 10 may be reduced accordingly.

In an embodiment, the baseboard management controller 112 may further receive a second data packet (hereinafter referred to as DA2) from the outside of the multi-node server network system 10, and the second data packet DA2 with the target address is, for example, a second port number (hereinafter referred to as PA2) of the second server node among the server nodes 121 to 12N.

For convenience in description, it is assumed that the second server node is considered as the server node 122. In this case, the second port number PA2 of the second data packet DA2 is, for example, “123.234.56.78:2” as shown in Table 1.

In an embodiment, when the user wants to access the server node 122, a data packet (for example, the second data packet DA2) with a target address “123.234.56.78:2” may be sent to the chassis manager 110 accordingly. However, the disclosure is not limited thereto.

In an embodiment, when the baseboard management controller 112 receives the second data packet DA2 with the second port number PA2, the baseboard management controller 112 may forward the second data packet DA2 to the network switch 114. Correspondingly, the network switch 114 may find a second virtual network address corresponding to the second port number PA2 based on the mapping table T (for example, the virtual network address “192.168.50.2” corresponding to the server node 122 in Table 1).

Afterwards, the network switch 114 of the chassis manager 110 may forward the second data packet DA2 to the second server node (for example, the server node 122) with the second virtual network address (for example, “192.168.50.2”). Based on this, when the server node 122 receives the second data packet DA2 from the network switch 114, the node baseboard management controller of the server node 122 may perform corresponding data processing on the second data packet DA2. However, the disclosure is not limited thereto.

From another point of view, in a scenario of Table 1, when the baseboard management controller 112 forwards a data packet (hereinafter referred to as DA) from the outside with a target address “123.234.56.78: i” to the network switch 114, the network switch 114 may find a corresponding virtual network address “192.168.50.i” based on FIG. 1, and then forward the data packet DA to a corresponding i-th server node. Thereby, each of the server nodes 121 to 12N may smoothly perform the data exchange with the external device without configuring the unique IP address for each of the server nodes 121 to 12N.

In summary, in the embodiment of the disclosure, the chassis manager may be configured with the corresponding virtual network address and the port number for each of the managed server nodes and may establish a corresponding mapping table accordingly. In this way, when the chassis manager receives the data packet whose target address is a certain port number from the outside of the multi-node server network, the chassis manager may find the corresponding virtual network address based on the established mapping table, and then forwards the data packet to the corresponding server node accordingly. Thereby, each of the server nodes may smoothly perform the data exchange with the external devices without configuring the unique IP address for each of the server nodes to reduce effects of deployment costs and complexity.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and their equivalents and not by the above detailed descriptions.

What is claimed is:

1. A multi-node server network system, comprising:
a chassis manager, managing a plurality of server nodes, wherein the chassis manager is configured to:
assign a plurality of virtual network addresses to the plurality of server nodes respectively;
set up a plurality of port numbers respectively for the plurality of server nodes based on a specific network address;
establish a mapping table between the plurality of virtual network addresses and the plurality of port numbers;
in response to receiving a first data packet corresponding to a first port number among the plurality of port numbers, find a first virtual network address corresponding to the first port number from the plurality of virtual network addresses based on the mapping table; and
forward the first data packet to a first server node corresponding to the first virtual network address among the plurality of server nodes.

2. The multi-node server network system according to claim 1, wherein the chassis manager comprises a baseboard management controller and a network switch, and the network switch is coupled to the baseboard management controller and the plurality of server nodes, the baseboard management controller is configured to:
assign the plurality of virtual network addresses to the plurality of server nodes respectively;
set up the plurality of port numbers respectively for the plurality of server nodes based on the specific network address;
establish the mapping table between the plurality of virtual network addresses and the plurality of port numbers and provide the mapping table to the network switch; and
in response to receiving the first data packet corresponding to the first port number among the plurality of port numbers, forward the first data packet to the network switch;
wherein the network switch is configured to:
find the first virtual network address corresponding to the first port number from the plurality of virtual network addresses based on the mapping table; and
forward the first data packet to the first server node corresponding to the first virtual network address among the plurality of server nodes.

3. The multi-node server network system according to claim 1, wherein a target address of the first data packet comprises the specific network address and the first port number.

4. The multi-node server network system according to claim 1, wherein the chassis manager is further configured to:
in response to receiving a second data packet corresponding to a second port number among the plurality of port numbers, find a second virtual network address corresponding to the second port number from the plurality of virtual network addresses based on the mapping table; and
forward the second data packet to a second server node corresponding to the second virtual network address among the plurality of server nodes.

5. The multi-node server network system according to claim 1, further comprising the plurality of server nodes, wherein each of the plurality of server nodes has a corresponding node baseboard management controller.
